(19) United States
(12) Patent Application Publication
(10) Pub. No.: US 2008/0287623 A1
(43) Pub. Date: Nov. 20, 2008

(54) Cure systems for rubber compounds

(76) Inventors: Michael B. Rodgers, Seabrook, TX (US); Nitin K. Tambe, Bangalore (IN); Scott C. Solis, Houston, TX (US); Bharat B. Sharma, Bangalore (IN)

Correspondence Address: ExxonMobil Chemical Company, P O Box 2149, Baytown, TX, 77522-2149, US

(21) Appl. No.: 11/804,071

(22) Filed: May 17, 2007

(51) Int. Cl. C08F 110/10; C08F 14/16; C08F 2/38

(52) U.S. Cl. 526/223

(57) ABSTRACT

The invention relates to the use of alkylphenol disulfide accelerators in butyl and halobutyl compounds.

### FIELD OF THE INVENTION

The invention relates to vulcanization of butyl rubber and halobutyl rubber compounds.

### BACKGROUND OF THE INVENTION

Isobutylene-based elastomers include butyl rubber and halogenated butyl rubber, and their respective star-branched versions. Due to their impermeability and resistance to heat and oxidation, these polymers find application in tire innerliners and innertubes, curing bladders and envelopes, and other applications where air retention and resistance to heat and oxidation are required. Butyl rubbers are produced via a cationic polymerization in methyl chloride at temperatures between −90° C. and −100° C. The unique properties and difficult manufacturing conditions place butyl rubbers in the special purpose elastomers category, distinct from general-purpose rubbers such as polybutadiene (BR), natural rubber (NR), and styrene-butadiene rubbers (SBR).

Halobutyl rubbers (BIIR and CIIR) incorporate a butyl backbone with either brominated or chlorinated isoprenoid units. The halogen increases the reactivity of the isoprenyl units located in the butyl polymer backbone. However, compared to general purpose elastomers, the relatively low amount of reactive sites may necessitate use of special cure systems.

The selection and type of a vulcanization system is a function of the profile for the final product, composite structure in which it may be used, and the product performance demands. Therefore, butyl and halobutyl compound cure systems may include organic accelerators along with resins, zinc oxide, zinc oxide and sulfur, and quinoid systems

The low number of unsaturated monomer units in isobutylene/isoprene copolymer (butyl rubber), usually in the order of 2%, has traditionally necessitated use of ultra-fast accelerators such as tetramethyl thiuram disulfide (TMTD) or zinc dimethyldithiocarbamate (ZMDC). Use of such accelerators can result in formation of nitrosamines which may be undesirable. There are a number of alternatives to TMTD and ZMDC cure systems such as use of xanthates and phosphate based accelerators, however these also have their problems such as performance with respect to scorch resistance.

The present inventor has surprisingly discovered that the use of alkylphenol disulfide accelerators enable attainment of favorable properties when used in butyl and halobutyl compounds.

### SUMMARY OF THE INVENTION

The invention is directed to the use of alkylphenol disulfide accelerators for vulcanizing isobutylene-based elastomers.

In embodiments comprising butyl rubber, use of alkylphenol disulfide accelerators provides improvements in one or more of reversion resistance, adhesion to natural rubber tire casing compounds.

In bromobutyl compounds containing alkylphenol disulfide accelerators in binary (two accelerators) or tertiary (three accelerators), adjustment in cure rate to meet specific requirements and aged property retention is possible.

It is an object of the invention to provide butyl rubber and halobutyl rubber compounds having improvements in at least one of reversion resistance, adhesion and tear strength, aged property retention, improved scorch resistance, and increased tensile strength and modulus.

Improvements in reversion resistance of isobutylene rubbers (i.e. at 180° C. and higher) are of particular importance given the demands for higher product cure temperatures and improved productivity. Aged property retention, tear strength, and adhesion are important for end product durability.

These and other objects, features, and advantages will become apparent as reference is made to the following detailed description, preferred embodiments, examples, and appended claims.

### BRIEF DESCRIPTION OF THE DRAWINGS

In the accompanying drawings, like reference numerals are used to denote like parts throughout the several views.

FIGS. 1, 2, and 4 illustrate rheometer profiles for embodiments of the invention.

FIG. 3 illustrates peel adhesion to natural rubber casing for various embodiments of the invention.

### DETAILED DESCRIPTION

According to the invention, alkyl phenol disulfide accelerators can be used in butyl rubber and halobutyl rubber curing systems.

Butyl rubber is a copolymer of isobutylene and isoprene, with isoprene typically being in the order of 2 mol %. Halobutyl rubbers are similar to Butyl rubber, except that chlorine or bromine is present in the majority of the isoprenoid units in the copolymer. Star-branched Butyl polymers (regular and halogenated), which are copolymers of isobutylene and isoprene, including a styrene block copolymer branching agent. There are also specialty elastomers which are brominated polymers derived from a copolymer of isobutylene and paramethylstyrene (PMS). As used herein, the term “isobutylene-based elastomer” includes all of these rubbers. See, for example, resources provided at www.butylrubber.com.

A schematic of the general structure of polymeric alkylphenol disulfide accelerators is illustrated in formula (1). Though these accelerators contain sulfur, the disulfide group may not be as reactive when compared to the —S—S— in TMTD due to steric hindrance of the phenol groups. R is independently selected from C3-C6 alkyl groups, n is independently selected from 1-5, and x is from 1 to 10. In the preferred embodiment, x is on the order of 5 and the average number sulfur atoms in the x subunit is about 2.1.

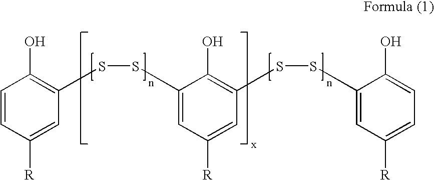

The invention is best illustrated by reference to the following experiments. The examples are meant to illustrate the present invention, and numerous modifications and variations are possible. It is to be understood that within the scope of the appended claims, the invention may be practiced otherwise than as specifically described herein.

Table I illustrates a model butyl rubber formulation that was used for evaluating the alkylphenol disulfide polymer based accelerators.

TABLE I
Model Butyl Rubber Screening Compound

| Material | (phr) |
|---|---|
| Butyl Rubber | 100.00 |
| Carbon Black (N660) | 70.00 |
| Paraffinic Oil | 25.00 |
| Phenolic Tackifying Resin | 4.00 |
| Stearic acid | 1.00 |
| Zinc oxide | 5.00 |
| Tetramethylthiuram disulfide (TMTD) | 1.00 |
| Mercaptobenzothiazole disulfide (MBTS) | 0.50 |
| Sulfur | 2.00 |

In Table II, a model bromobutyl rubber compound is illustrated that was also used for cure system studies.

TABLE II
Model Bromobutyl Screening Compound

| Material | (phr) |
|---|---|
| Bromobutyl Rubber | 100.00 |
| Carbon Black (N660) | 60.00 |
| Naphthenic Oil | 8.00 |
| Aromatic Hydrocarbon Resin | 7.00 |
| Phenolic Tackifying Resin | 4.00 |
| Stearic acid | 1.00 |
| Zinc oxide | 1.00 |
| Mercaptobenzothiazole disulfide (MBTS) | 1.25 |
| Sulfur | 0.50 |

Table III contains a description of four alkylphenol disulfide polymer accelerators that have been studied. For convenience the accelerators have been abbreviated as V3, V5, V710, and VTB710.

TABLE III
Vultac Series of Accelerators

| | | | Composition | | Nominal |
|---|---|---|---|---|---|
| | | | (wt %) | | Sulfur |
| | | Active | Silica | Stearic | Content |
| Abbreviation | Descrption | Component | Gel | Acid | (wt %) |
| V3 | t-Amylphenol Disulfide Polymer | 100 | — | — | 28 |
| V5 | t-Amylphenol Disulfide Polymer | 75 | 25 | — | 21 |
| V710 | t-Amylphenol Disulfide Polymer | 90 | — | 10 | 28 |
| VTB710 | t-Butylphenol Disulfide Polymer | 90 | — | 10 | 28 |

The four alkylphenol disulfide polymer accelerators, identified as V3, V5, V710 and VTB710 (Tables above), were evaluated in three screening studies, (i) in a butyl compound containing a EV sulfur cure system (high amount of sulfur relative to a semi-EV sulfur cure system) (ii) in a butyl compound with a semi-EV sulfur cure system and (iii) in a bromobutyl compound. V710 was then studied in a designed experiment where the alkylphenol disulfide was varied as part of a 3-variable central composite design.

TABLE IV
Screening of V3, V5, V710, and VTB710 in a Butyl EV-Cure
Compound

| | Compound | | | | |
|---|---|---|---|---|---|
| | 1 | 2 | 3 | 4 | 5 |
| Exxon Butyl ™ 268 | 100.00 | 100.00 | 100.00 | 100.00 | 100.00 |
| (PHR) | | | | | |
| Carbon Black N660 | 70.00 | 70.00 | 70.00 | 70.00 | 70.00 |
| Paraffinic oil | 25.00 | 25.00 | 25.00 | 25.00 | 25.00 |
| Phenolic Tackifying | 4.00 | 4.00 | 4.00 | 4.00 | 4.00 |
| Resin | | | | | |
| Stearic acid | 1.00 | 1.00 | 1.00 | 1.00 | 1.00 |
| ZnO | 5.00 | 5.00 | 5.00 | 5.00 | 5.00 |
| MBTS (Appendix 1) | 0.50 | 0.50 | 0.50 | 0.50 | 0.50 |
| TMTD (Appendix 1) | 1.00 | | | | |
| V3 | | 3.00 | | | |
| V5 | | | 3.00 | | |
| V710 | | | | 3.00 | |
| VTB710 | | | | | 3.00 |
| Mooney Viscosity | | | | | |
| (100° C.) | | | | | |
| ML1 + 4 [MU] | 46 | 46 | 45 | 45 | 44 |
| Rheometer (MDR), | | | | | |
| 160° C. | | | | | |
| MH-ML [dNm] | 1.4 | 3.5 | 2.7 | 2.8 | 3.4 |
| t10 [Min] | 2.1 | 6.8 | 6.9 | 5.6 | 7.1 |
| t90 [Min] | 7.6 | 45.9 | 44.1 | 42.5 | 45.4 |
| CRI | 18.2 | 2.6 | 2.7 | 2.7 | 2.6 |
| Rheometer (MDR), | | | | | |
| 180° C. | | | | | |
| MH-ML [dNm] | 1.2 | 3.8 | 2.8 | 3.0 | 3.7 |
| t10 [Min] | 0.8 | 2.0 | 2.1 | 1.7 | 2.1 |
| t90 [Min] | 2.4 | 10.6 | 10.1 | 9.7 | 10.4 |
| CRI | 63.3 | 11.6 | 12.5 | 12.5 | 12.0 |
| 300% Modulus [MPa] | 0.63 | 1.20 | 0.75 | 1.53 | 0.95 |
| Aged Tensile Strength | | | | | |
| Aged 72 hrs at 100° C. | | | | | |
| 300 Modulus [MPa] | 1.85 | 2.08 | 1.46 | 2.29 | 1.83 |
| Original/Aged 300% | 34 | 58 | 51 | 67 | 52 |
| Modulus Ratio | | | | | |
| Tear Strength [N/mm] | 20.2 | 28.9 | 27.6 | 35.2 | 33.9 |
| (ASTM D624, Die B) | | | | | |
| Adhesion to Model | | | | | |
| Natural Rubber | | | | | |
| Casing Compound | | | | | |
| PeakLoad [N] | 73.3 | 221.7 | 202.8 | 97.4 | 141.2 |

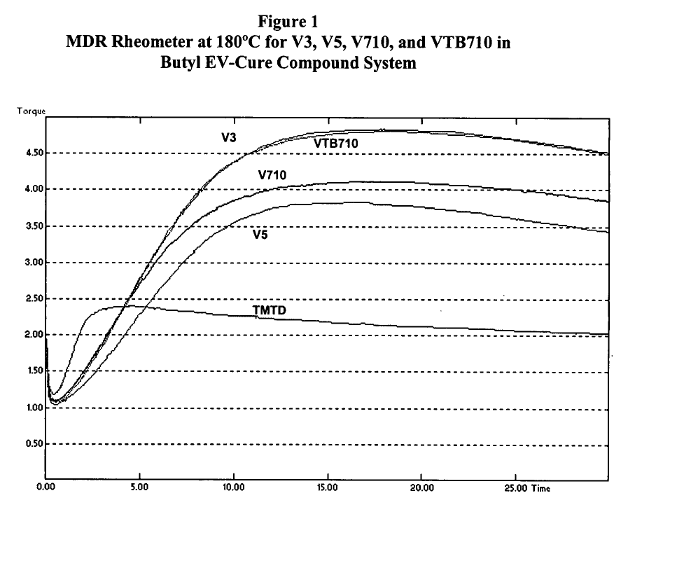

Alkylphenol disulfide polymer accelerators are reported to be sulfur donors. To explore this using the butyl screening compound (Table I), the four alkylphenol disulfide accelerators were evaluated at 3.0 phr in place of tetramethylthiuram disulfide (TMTD). Since the study was a basic screening study of the accelerators, no adjustment in loading due to the silica gel or stearic acid extension was made. A summary of the compound properties is illustrated in Table V. Replacing TMTD with the alkylphenol disulfide accelerators permitted the following observations:
1. The accelerators had no effect on compound viscosity.
2. Rheometer induction time (t₁₀) and cure times (t₉₀) were much longer than that for the TMTD compound. However, viewing FIG. 1, it is seen that the cure state (MH-ML or ΔT) of the TMTD cured compound is much lower, and the compound starts to revert earlier than the alkylphenol disulfide polymer accelerators.
3. The alkylphenol disulfide accelerator, V5, displayed the lowest state of cure, most likely due to the level of silica gel carrier.
4. Use of the alkylphenol disulfide accelerators led to an increase in compound tear strength and significant improvement in adhesion. There is also a directional improvement in aged modulus retention (3 days at 100° C.).

TABLE V
Vulcanization Kinetics of V3, V5, V710, and VTB710 in
a Butyl EV-Cure Compound

| | Compound | | | | |
|---|---|---|---|---|---|
| | 1 | 2 | 3 | 4 | 5 |
| Accelerator | TMTD | V3 | V5 | V710 | VTB710 |
| Cure Rate 160° C. | 0.31 | 0.12 | 0.10 | 0.11 | 0.13 |
| Cure Rate 180° C. | 0.82 | 0.46 | 0.37 | 0.45 | 0.49 |
| Apparent Activation | 79.33 | 109.58 | 106.69 | 114.88 | 108.20 |
| Energy aEa (KJ/mol) | | | | | |

Table VI shows the cure rate and apparent activation energy data for the five compounds. The cure rates are lower and the activation energy is greater for the alkylphenol disulfide accelerators. This is most likely due to the steric bulk of the t-amylphenol and t-butylphenol groups in the accelerators and the effect on the reactivity of the —S—S— group. However, as the vulcanization process continues, as seen in Table III more sulfur will be available from the alkylphenol disulfides than from TMTD due to (i) the concentration of the alkylphenol disulfides and (ii) TMTD only contains 19% available sulfur, assuming that only —S—S— and no —C═S is available for crosslinking, compared to 20% to 28% for V3, V5, V710 and VTB710. Thus a higher state of cure can be attained.

TABLE VI
Screening of V3, V5, V710, and VTB710 with a Butyl Semi-EV
Cure System

| | Compound | | | | |
|---|---|---|---|---|---|
| | 6 | 7 | 8 | 9 | 10 |
| Exxon Butyl ™ 268 | 100.00 | 100.00 | 100.00 | 100.00 | 100.00 |
| PHR | | | | | |
| Carbon Black N660 | 70.00 | 70.00 | 70.00 | 70.00 | 70.00 |
| Paraffinic oil | 25.00 | 25.00 | 25.00 | 25.00 | 25.00 |
| Phenolic Tackifying | 4.00 | 4.00 | 4.00 | 4.00 | 4.00 |
| Resin | | | | | |
| Stearic acid | 1.00 | 1.00 | 1.00 | 1.00 | 1.00 |
| ZnO | 5.00 | 5.00 | 5.00 | 5.00 | 5.00 |
| MBTS (Appendix 1) | 0.50 | 0.50 | 0.50 | 0.50 | 0.50 |
| Sulfur | 2.00 | 2.00 | 2.00 | 2.00 | 2.00 |
| TMTD (Appendix 1) | 1.00 | | | | |
| V3 | | 3.00 | | | |
| V5 | | | 3.00 | | |
| V710 | | | | 3.00 | |
| VTB710 | | | | | 3.00 |
| Mooney Viscosity | | | | | |
| (100° C.) | | | | | |
| ML1 + 4 [MU] | 46 | 49 | 45 | 47 | 47 |
| Rheometer (MDR), | | | | | |
| 160° C. | | | | | |
| MH-ML [dNm] | 11.0 | 6.0 | 5.3 | 6.1 | 6.1 |
| t10 [Min] | 1.8 | 6.1 | 6.0 | 5.4 | 6.4 |
| t90 [Min] | 19.3 | 40.6 | 42.0 | 39.5 | 43.4 |
| PeakRate [dNm/min] | 2.4 | 0.3 | 0.3 | 0.3 | 0.3 |
| CRI | 5.7 | 2.9 | 2.8 | 2.9 | 2.7 |
| Rheometer (MDR), | | | | | |
| 180° C. | | | | | |
| MH-ML [dNm] | 9.2 | 5.7 | 5.5 | 6.3 | 6.4 |
| t10 [Min] | 0.7 | 1.6 | 1.6 | 1.5 | 1.7 |
| t90 [Min] | 4.5 | 7.2 | 9.9 | 8.4 | 10.3 |
| PeakRate [dNm/min] | 6.1 | 1.2 | 1.2 | 1.3 | 1.2 |
| CRI | 26.7 | 17.9 | 12.1 | 14.6 | 11.7 |
| Tensile Strength [MPa] | 11.1 | 9.3 | 9.8 | 10.4 | 9.6 |
| Elongation [%] | 660 | 842 | 855 | 805 | 785 |
| 100% Modulus [MPa] | 1.5 | 0.8 | 0.8 | 0.9 | 0.8 |
| 200% Modulus [MPa] | 2.8 | 1.2 | 1.2 | 1.5 | 1.4 |
| 300% Modulus [MPa] | 4.2 | 1.8 | 1.8 | 2.3 | 2.1 |

In summary this screening study has shown that alkylphenol disulfide polymer accelerators can allow improvements in:
1. Reversion resistance.
2. Adhesion and tear strength.
3. Aged property retention.

### EXAMPLE 3

### Screening of V3, V5, V710, and VTB710 with a Butyl Semi-EV Cure System

The four alkylphenol disulfide accelerators, V3, V5, V710, and VTB710, were screened using the model butyl rubber formulation shown in Table I, with sulfur at 2.0 phr, and the results have been listed in Table VI. From Table VI it can be noted that:
1. The alkylphenol disulfide accelerators had no effect on compound viscosity, as might be expected.
2. TMTD had much shorter rheometer induction (t₁₀), cure time (t₉₀), and faster cure rate. The cure state (rheometer ΔT) was also greater. This was also seen in higher tensile strength and 300% modulus.

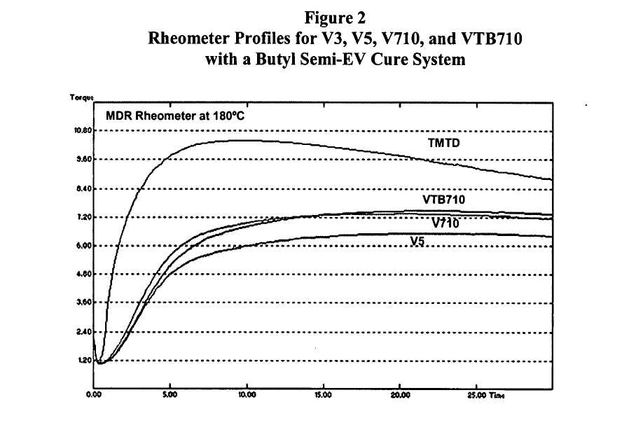

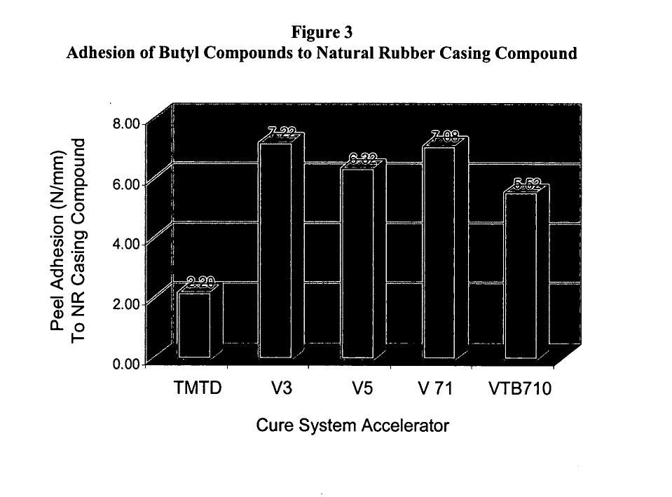

The rheometer profiles are illustrated in FIG. 2. Though the compound containing TMTD showed higher cure state and tensile strength, it is more susceptible to reversion compared to the alkylphenol disulfide cured compounds. This is further shown in aged tensile strength retention properties. Table VII compares the % retained tensile strength for the TMTD (81%) after 72 hours at 100 C, with V3, V5, V710, and VTB710 cured compounds (93%, 93%, 91%, and 92% respectively). Adhesion of V3, V5, V710, and VTB710 cured compounds is also much better than with the TMTD compound though in this instance the compound tack data are all equivalent.

TABLE VII
Compound Properties with V3, V5, V710, and VTB710
in a Butyl Semi-EV Cure System

| | Compound | | | | |
|---|---|---|---|---|---|
| | 6 | 7 | 8 | 9 | 10 |
| Exxon Butyl ™ 268 | 100.00 | 100.00 | 100.00 | 100.00 | 100.00 |
| PHR | | | | | |
| Carbon Black N660 | 70.00 | 70.00 | 70.00 | 70.00 | 70.00 |
| Paraffinic oil | 25.00 | 25.00 | 25.00 | 25.00 | 25.00 |
| Phenolic Tackifying | 4.00 | 4.00 | 4.00 | 4.00 | 4.00 |
| Resin | | | | | |
| Stearic acid | 1.00 | 1.00 | 1.00 | 1.00 | 1.00 |
| ZnO | 5.00 | 5.00 | 5.00 | 5.00 | 5.00 |
| MBTS (Appendix 1) | 0.50 | 0.50 | 0.50 | 0.50 | 0.50 |
| Sulfur | 2.00 | 2.00 | 2.00 | 2.00 | 2.00 |
| TMTD (Appendix 1) | 1.00 | | | | |
| V3 | | 3.00 | | | |
| V5 | | | 3.00 | | |
| V710 | | | | 3.00 | |
| VTB710 | | | | | 3.00 |
| Aged Tensile | | | | | |
| Aged 72 hours at 100° C. | | | | | |
| Tensile strength [MPa] | 10.10 | 9.28 | 9.14 | 9.48 | 9.19 |
| Elongation [%] | 538 | 782 | 798 | 731 | 723 |
| Aged Tensile | | | | | |
| Strength Retention | | | | | |
| Elongation % | 81 | 93 | 93 | 91 | 92 |
| Tensile % | 91 | 99 | 94 | 91 | 96 |
| Peel Adhesion to | | | | | |
| Model Natural | | | | | |
| Rubber Casing | | | | | |
| Compound | | | | | |
| PeakLoad [N] | 4.11 | 8.94 | 8.23 | 8.77 | 7.39 |
| TearResist [N/mm] | 2.20 | 7.22 | 6.32 | 7.08 | 5.52 |
| Teltak Tack Test | | | | | |
| Tack [kPa] | 137.8 | 137.8 | 144.69 | 133.67 | 137.8 |

In summary, for semi-EV cure systems in butyl compounds, use of alkylphenol disulfide polymer cured compounds may allow improvements in:
1. Reversion resistance.
2. Adhesion.
3. Better retention of aged properties.

Table VIII tabulates the cure systems apparent activation energy data, showing this is higher for the alkylphenol disulfide cured compounds. This observation is in agreement with earlier data and is most likely due to the steric bulk and benzylic nature of the t-amylphenol and t-butylphenol groups in the accelerators initially stabilizing and reducing access to the —S—S— bonds.

TABLE VIII
Vulcanization Kinetics of V3, V5, V710, and VTB710
in a Butyl Semi-EV Cure System

| | Compound | | | | |
|---|---|---|---|---|---|
| | 6 | 7 | 8 | 9 | 10 |
| Accelerator | TMTD | V3 | V5 | V710 | VTB710 |
| Cure Rate 160 c | 2.43 | 0.26 | 0.25 | 0.30 | 0.25 |
| Cure Rate 180 c | 6.07 | 1.17 | 1.16 | 1.33 | 1.19 |
| Apparent Activation | 74.66 | 122.66 | 125.15 | 121.44 | 127.24 |
| Energy aEa (KJ/mol) | | | | | |

### EXAMPLE 4

### Screening of V3, V5, V710, and VTB710 with a Bromobutyl Model Compound

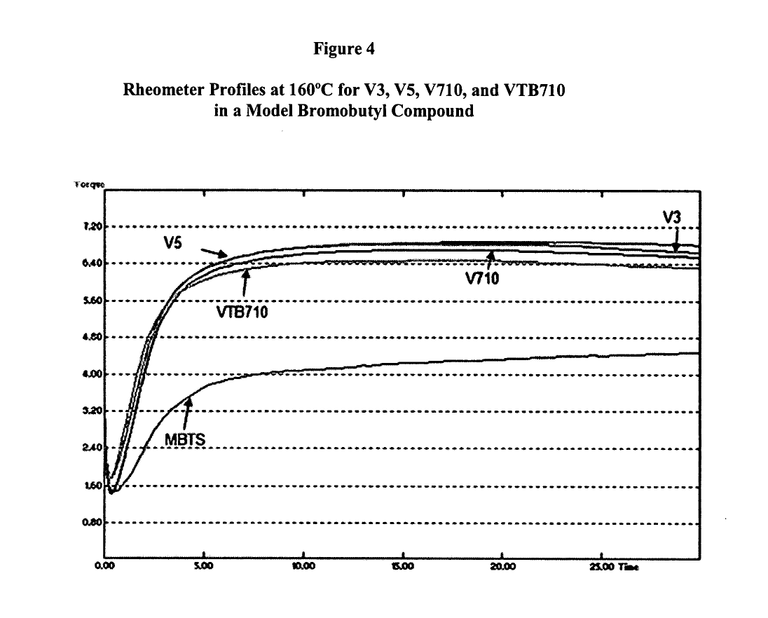

The four alkylphenol disulfide accelerators were screened in the model bromobutyl rubber formulation shown in Table II. MBTS was not adjusted with the addition of the alkylphenol disulfide polymer accelerators To compensate for potential over cure, the levels of V3, V5, V710, and VTB710 were reduced from 3.0 phr used in the butyl compound screening work to 2.0 phr. Table IX shows the results of the screening work in the model bromobutyl compound. Briefly:
1. Rheometer induction times (t₁₀) and cure times (t₉₀) were shorter with addition of the alkylphenol disulfide polymer accelerators.
2. Cure state (rheometer ΔT) was higher. Given the high state of cure (FIG. 4), synergistic effects between the MBTS and V3, V5, V710, or VTB710 could be speculated.
3. Addition of alkylphenol disulfide accelerators resulted in an increase in tensile strength and modulus. Tear strength and hardness were essentially equivalent to the control compound (Compound II).

Viewing the results obtained, the present inventors believe that the attainment of a desired set of compound properties optimizing all of the components in the cure system is within the skill of the ordinary artisan in possession of the present disclosure.

More specifically, the results show that for bromobutyl compound cure systems containing MBTS, use of alkylphenol disulfide polymer cured compounds may allow improvements in:
4. Tensile strength and 300% modulus.
5. Cure rate.
6. Increase in state of cure (MH-ML or ΔT).

TABLE IX
Screening of V3, V5, V710, and VTB710
in a Bromobutyl Model Compound

| | Compound | | | | |
|---|---|---|---|---|---|
| | 11 | 12 | 13 | 14 | 15 |
| EXXON ™ Bromobutyl | 100.00 | 100.00 | 100.00 | 100.00 | 100.00 |
| 2222 (PHR) | | | | | |
| Carbon Black N660 | 60.00 | 60.00 | 60.00 | 60.00 | 60.00 |
| Naphthenic Oil | 8.00 | 8.00 | 8.00 | 8.00 | 8.00 |
| Aliphatic & Aromatic | 7.00 | 7.00 | 7.00 | 7.00 | 7.00 |
| Resin Blend | | | | | |
| Phenolic Tackifying | 4.00 | 4.00 | 4.00 | 4.00 | 4.00 |
| Resin | | | | | |
| Stearic Acid | 1.00 | 1.00 | 1.00 | 1.00 | 1.00 |
| ZnO | 1.00 | 1.00 | 1.00 | 1.00 | 1.00 |
| MBTS (Appendix) | 1.25 | 1.25 | 1.25 | 1.25 | 1.25 |
| Sulfur | 0.50 | 0.50 | 0.50 | 0.50 | 0.50 |
| V3 | | 2.00 | | | |
| V5 | | | 2.00 | | |
| V710 | | | | 2.00 | |
| VTB710 | | | | | 2.00 |
| Mooney Viscosity | | | | | |
| (100° C.) | | | | | |
| ML1 + 4 [MU] | 58 | 57 | 70 | 56 | 79 |
| Rheometer (MDR), | | | | | |
| 160° C. | | | | | |
| MH-ML [dNM] | 3.0 | 5.4 | 5.1 | 5.3 | 4.7 |
| t10 [Min] | 1.2 | 0.9 | 0.8 | 0.9 | 0.7 |
| t90 [Min] | 13.0 | 5.0 | 5.5 | 5.2 | 4.9 |
| PeakRate [dNm/min] | 0.9 | 1.9 | 1.8 | 1.9 | 2.0 |
| 180° C. | | | | | |
| MH-ML [dNM] | 2.8 | 5.1 | 4.9 | 5.0 | 4.5 |
| t10 [Min] | 0.6 | 0.5 | 0.5 | 0.5 | 0.4 |
| t90 [Min] | 3.2 | 1.6 | 1.7 | 1.6 | 1.5 |
| PeakRate [dNm/min] | 2.5 | 6.0 | 5.7 | 6.1 | 5.8 |
| Tensile Strength [MPa] | 8.9 | 10.5 | 11.4 | 10.4 | 10.7 |
| Elongation [%] | 778 | 749 | 739 | 761 | 654 |
| 100 Modulus [MPa] | 1.0 | 1.3 | 1.6 | 1.2 | 2.0 |
| 200 Modulus [MPa] | 2.0 | 27 | 3.7 | 26 | 4.3 |
| 300 Modulus ]MPa] | 3.2 | 4.0 | 5.5 | 3.9 | 6.0 |
| Hardness A [Shore A] | 41 | 39 | 41 | 42 | 41 |
| Tear Strength [N/mm] | 46.4 | 46.0 | 54.0 | 47.4 | 52.5 |
| (ASTMD624, Die B) | | | | | |

Butyl rubber compounds were prepared via a two-stage mix cycle. Using a Farrell BR Banbury and starting at 50° C., the rubber was first premasticated. Carbon black, oil, and other compounding ingredients were then added and the 1st pass or non-productive dropped at 150° C. Mix times were in the order of 5 minutes. The final or productive compound containing the cure systems was prepared by a similar process but using a drop or dump temperature of 100° C. The final productive stage mix time was typically in the order of 90 seconds.

The bromobutyl compound was also mixed in a two stage process but where the non-productive was dropped at 135° C. to 140° C.

Mooney viscosity and Mooney scorch values were determined as described in ASTM D1646. Tensile strength and tear strength properties where measured according to ASTM D412 and D624, respectively. Test samples were vulcanized at 160° C. and compound cure times were set by adding two minutes to the rheometer t90 cure time.

MDR12000 rheometer (Alpha Technologies) was used to determine compound cure kinetics according to ASTM D5289. The rheometer report gave the rate of vulcanization, which was calculated from the tangent of the cure curve at t50. A cure rate index was also calculated from equation 1. This is a simple calculation, but readily permits a relative ranking of cure rates.

C.R.I=100/(t90−t10)

In earlier work with samples cured at 140° C., the rate of reaction was slow, most likely due to the low unsaturation levels of butyl polymers when compared to general purpose elastomers. Thus, in order to obtain insight into the mechanism of vulcanization, an ‘apparent’ activation energy was calculated from the vulcanization kinetic data generated at 160° C. and 170° C. or 180° C. using the Arrhenius equation which is typically written as:

k=Ae^{-E}a^{/RT}

where k is the rate constant, A is a constant, Eₐ is the energy of activation, R is the gas constant (Joules mole⁻¹° K⁻¹), and T₁ and T₂ are the absolute temperatures in ° K. When k′ and k″ are the rate constants at temperatures T₁ and T₂, the ‘apparent’ activation energy can be determined by rearranging equation 2 to give:

log₁₀k″/k′=(Eₐ/2.3026R)(1/T₂−1/T₁)

log k″−log k′=(Eₐ/2.3026R)(T₂−T₁/T₁T₂)

Eₐ=4.576T₁T₂(log k″−log k′)/(T₂−T₁)

This empirical approach to estimating an ‘apparent’ activation energy is based on the observation that a plot of the vulcanization rate against the reciprocal of absolute temperature is a straight line. The approach can thus serve many uses such as estimates of the temperature coefficient of vulcanization, necessary for calculating cure units and cure equivalents, for setting product cure time. This technique for estimating ‘apparent’ activation energy has been reported to be satisfactory for natural rubber compounds over the range of 125° C. to 169° C.

For isobutylene based polymers and their derivatives, which have very low unsaturation levels the ‘apparent’ activation energy has been considered only within the range of 160° C. to 180° C. Unlike general purpose elastomers with a semi-EV (semi-efficient vulcanization) cure system, highly saturated elastomers requiring ultra accelerators and low sulfur concentrations may have a broader range of crosslink types ranging from S₁ to S₄. By considering the ‘apparent’ activation energy within a narrow temperature range, and also at typical product curing temperatures, satisfactory data could be achieved.

Oxygen permeability was measured using a Mocon Ox-Tran Model 2/61 oxygen transmission rate test apparatus and Perm-Net operating system. There are six cells per instrument where gas transmission through each test sample in a cell is measured individually. A zero reading to establish a baseline and test samples is then measured at 40° C. and 60° C. Oxygen transmission is measured with an O2 detector. Data is reported as a Permeation Coefficient in cc*mm/(m2-day) and Permeability Coefficient in cc*mm/(m2-day-mmHg). Permeability is then expressed as a rating relative to the control compound. The model compound illustrated in Table II is assigned a rating of 100. This control compound has a nominal permeation coefficient at 60° C. of 500 to 550 cc*mm/(m2-day)8.9.10.

Trade names used herein are indicated by a ™ symbol or ® symbol, indicating that the names may be protected by certain trademark rights, e.g., they may be registered trademarks in various jurisdictions.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The invention has been described above with reference to numerous embodiments and specific examples. Many variations will suggest themselves to those skilled in this art in light of the above detailed description. All such obvious variations are within the full intended scope of the appended claims.

What is claimed is:

1. In a curable composition for making isobutylene-based elastomers, the improvement comprising alkylphenol disulfide accelerators, optionally further comprising EV and/or semi-EV cure systems.

2. The mixture according to claim 1, wherein said alkylphenol disulfide accelerators is selected from at least one of formula (1), 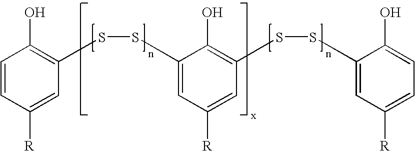
wherein each R is independently selected from C3-C6 alkyl groups, each n is independently selected from 1-5 and x is from 1 to 10.

3. The mixture according to claim 1, wherein said isobutylene-based elastomer is butyl rubber.

4. The mixture according to claim 1, wherein said isobutylene-based elastomer is halobutyl rubber.

5. The mixture according to claim 1, wherein said isobutylene-based elastomer is bromobutyl rubber.

6. The mixture according to claim 1, wherein said alkylphenol disulfide accelerator has at least one tertiary carbon in the alkyl side chain.

7. The mixture according to claim 1, wherein said alkylphenol disulfide accelerator is selected from at least one of t-amylphenol disulfide and t-butylphenol disulfide.

8. In a process comprising vulcanization of isobutylene-based elastomers, the improvement comprising the use of alkylphenol disulfide accelerators.

9. The process according to claim 8, wherein said alkylphenol disulfide accelerators is selected from at least one of formula (I), 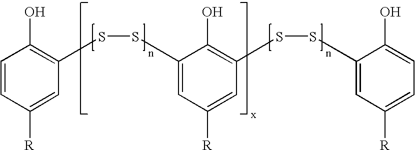
wherein each R is independently selected from C3-C6 alkyl groups, each n is independently selected from 1-5 and x is from 1 to 10.

10. The process according to claim 8, comprising vulcanization of butyl rubber.

11. The process according to claim 8, comprising vulcanization of halobutyl rubber.

12. The process according to claim 8, comprising vulcanization of bromobutyl rubber.

13. The process according to claim 8, wherein said alkylphenol disulfide accelerator has at least one tertiary carbon in the alkyl side chain.

14. The process according to claim 8, wherein said alkylphenol disulfide accelerator is selected from at least one of t-amylphenol disulfide and t-butylphenol disulfide.

15. A cured isobutylene-based elastomer made by a process including vulcanization of the composition according to claim 1.

16. A cured isobutylene-based elastomer made by the process of claim 8.

17. An article including an interliner or innertube comprising the cured isobutylene-based elastomer of claim 15.

18. An article including an interliner or innertube comprising the cured isobutylene-based elastomer of claim 16.

19. An article according to claim 17, wherein said article is a tire.
